(19) United States
(12) Patent Application Publication
(10) Pub. No.: US 2008/0262395 A1
(43) Pub. Date: Oct. 23, 2008

(54) Therapeutic Apparatus and a Method of Treatment Using the Apparatus

(75) Inventor: Emmanuel William Varipatis, Mosman (AU)

Correspondence Address: KELLY LOWRY & KELLEY, LLP, 6320 CANOGA AVENUE, SUITE 1650, WOODLAND HILLS, CA, 91367, US

(73) Assignee: PHOENIX MOON (HOLDINGS) PTY LTD., Surry Hills (AU)

(21) Appl. No.: 10/598,455

(22) PCT Filed: Feb. 24, 2005
(86) PCT No.: PCT/AU05/00247

§ 371 Date: May 14, 2007

(30) Foreign Application Priority Data
Mar. 3, 2004 (AU) 2004901123

(51) Int. Cl. A61H 33/06; A61H 1/00

(52) U.S. Cl. 601/17; 607/104

(57) ABSTRACT

A therapeutic apparatus is disclosed including a tank arranged to hold a body of fluid being sufficiently deep to submerge an upright person at least up to their neck; and means for agitating the fluid to effect a perturbation massage upon a person submerged in the fluid to mobilise toxins in the person's lymph system.

### TECHNICAL FIELD

This invention relates to a therapeutic apparatus and a method of treatment using the apparatus.

### BACKGROUND TO THE INVENTION

The lymphatic system is an extensive drainage system that transports water and molecules from tissue to the bloodstream in a liquid known as lymph. The lymph flows from the tissue to the blood stream via a network of lymphatic vessels that return the lymph to the bloodstream via a large vein that is located in the upper chest (near the neck). One of the major lymphatic vessels is the thoracic duct which receives lymph from the pelvis, lower limbs, abdomen, and lower chest and returns the lymph to the bloodstream via a large vein in the upper chest.

In addition to returning water and molecules to the bloodstream, the lymphatic system also serves to filter out foreign materials such as microorganisms and toxins. This filtering process is carried out by lymph nodes which lie along the network of lymphatic vessels. Lymph nodes are swollen nodes along the lympatic vessels which consist of a fine network of tissue that contains macrophage. Microorganisms and toxins that are contained in the lymph are trapped as the lymph passes through the lymph node and subsequently phagocytised by the macrophages to thereby remove the foreign material and toxins from the lymph prior to re-entry of the lymph into the bloodstream.

The amount of toxins that remain in the lymph following processing in the lymph nodes is generally greatly reduced if not eliminated. Following entry of the lymph into the bloodstream, removal of the remaining toxins is completed mainly by the liver and kidney and through the skin.

Under some circumstances, however, the lymph nodes may be overwhelmed with microorganisms and/or toxins, resulting in accumulation of toxins in the lymph nodes and lymphatic system. This reduces the effectiveness of the lymph nodes and can lead to further accumulation of toxins, resulting in low energy levels, fatigue, general malaise, muscle pain, poor mental state, poor skin tone, insomnia or restless sleep.

It has been tried to assist in the expulsion of these toxins from the body by performing a lymphatic drainage massage. In such a massage, a skilled masseur manipulates a person at regions of their body associated with the lymph system to mobilise the contents of the lymph system to encourage drainage into the blood system and subsequent processing by the liver. Such a massage can be time consuming and requires a skilled masseur.

Further, subjects have reported that following such a massage they often feel very unwell. This is thought to be due to the increased level of toxins in the blood due to the mobilisation of the lymph fluid caused by the massage.

### SUMMARY OF THE INVENTION

In a first aspect the present invention provides a therapeutic apparatus including: a tank arranged to hold a body of fluid being sufficiently deep to submerge an upright person at least up to their neck; means for agitating the fluid to effect a perturbation massage upon a person submerged in the fluid to mobilise toxins in the person's lymph system.

When submerged in the tank, the person is subjected to a perturbation massage caused by the agitation of the fluid. This mobilises substances in the lymph system of the person. Further, there is a pressure gradient in the tank due to the weight of the fluid. The pressure is greatest at the bottom of the tank and decreases upwardly to atmospheric pressure at the surface of the fluid at a point near to the neck of the person. This pressure gradient naturally urges lymphatic fluid upwards in the body towards the neck. Fluid in the head area drains downwardly under the force of gravity. Lymph from the lower periphery and trunk drains into the lymphatic duct from which the lymph drains into the blood system at the base of the left subclavian vein at the junction of the left subclavian and internal jugular veins. The combined effect of the pressure gradient in the tank and the mobilisation of lymph fluid assists in lymphatic drainage. This lymphatic drainage is achieved without the need to employ a skilled masseur.

The body of fluid and the fluid may have a density greater than water. This provides a greater pressure gradient in the tank and increases the tendency for lymph fluid to drain upwardly.

The fluid may be a mixture of water and a salt. The salt may include a salt of magnesium such as magnesium sulphate.

The means for agitating may include a pump and an arrangement of nozzles for delivering jets of pressurised fluid. The nozzles may be arranged to rotate.

The apparatus may further include means to maintain the person in the submerged position such as a system of weights or tethers. This is because the buoyancy of the person may need to be counteracted to maintain them in a submerged position about up to their neck. This is particularly the case where a fluid that is more dense than water is utilised.

In a second aspect the present invention provides a method of effecting lymphatic drainage in a person including the steps of: submerging the person in a body of fluid up to about their neck and in a substantially vertical orientation; and agitating the fluid to effect a perturbation massage upon the person submerged in the fluid to mobilise toxins in the person's lymphatic system.

In a third aspect the present invention provides a therapeutic method including the steps of: submerging the person in a body of fluid up to about their neck and in a substantially vertical orientation; and agitating the fluid to effect a perturbation massage upon the person submerged in the fluid.

In a fourth aspect the present invention provides a method of treating a condition in a person comprising the steps of: submerging the person in a body of fluid up to about their neck and in a substantially vertical orientation; and agitating the fluid to effect a perturbation massage upon the person submerged in the fluid to mobilise toxins in the person's lymphatic system.

The mobilised toxins are carried by the draining lymph into the person's blood stream from where the toxins can be removed from the person's body through organs such as the liver, kidney and skin.

Mobilised toxins may be removed from the person's bloodstream via the skin through perspiration. Thus, the method may further comprise the step of elevating the body temperature of the person to thereby cause the person to perspire. The body temperature may be elevated while the person is submerged in the fluid, or subsequent to removal of the person from the fluid.

The body temperature of the person may be elevated by any means that causes the person to perspire. The body temperature may be elevated by exposing the person to an amount of infra-red radiation that is sufficient to cause the person to perspire. The person may be exposed to infra-red radiation in an infra-red sauna. The infra-red sauna may be a far infra-red sauna. The far infra-red sauna may be operated at a temperature of between 50° and 70°.

The body temperature of the person may be elevated by elevating the temperature of the fluid in which the person is submerged to a temperature that causes the person to perspire.

The condition may be a condition that results from toxins in the lymphatic system of the person. Without wishing to be bound by theory, the inventor believes that some conditions result from toxins in the lymphatic system of a person, and that a method which effects lymphatic drainage may be used to treat such conditions. The condition may be associated with one or more of the following: low energy levels, fatigue, general malaise, muscle pain, poor mental state, poor skin tone, insomnia or restless sleep.

The condition may result from exposure to toxins from the environment. Toxins from the environment may include, for example, pesticides such as organophosphates, organochlorines, carbamates, pyrethrums, herbicides, insecticides, plastics such as formaldehyde, phenol, phthalates, vinyl chloride, dioxins, bisphenol A, PBDE's, toxic metals such as aluminium, arsenic, lead, mercury, organic pollutants such as PCB's, dioxins, furans, PCBD's, trichloromethane, organochlorine pesticides, cosmetics and perfumes such as acetone, benzaldehyde, ethanol, phthalates, lead, paints constituents such as benzene, diisocyanates, toluene, trichloroethane, xylene, inorganic compounds such as flourides, nitrates/nitrites, nitrogen dioxide, sulphur dioxide, ozone, phosphates, sodium hypochlorite, sulphites, ink constituents such as benzene, formaldehyde, phenol, petrol constituents such as benzene, ethylene dibromide, hexanes, toluene, trimethylpentane, xylene, MTBT, food and drug preservatives such as butylated hydroxyl anisole, butylated hydroxytoluene, nitrites, sulfites, thimersol, food contaminants such as lipid peroxidase, trans fatty acids, acrylamides, polycyclic aromatic hydrocarbons, mycotoxins, fungicides, herbicides, insecticides, antibiotics, hormones, mercury, lead, cadmium, water contaminants such as trichloromethanes, arsenic, flouride, aluminium, lead, nitrates, volatile organic compounds, cleaning compounds such as ethylene dichloride, tetrachhloroethylene, trichloroethylene, trichloroethane, ammonia, enzymes, formaldehyde, perfume, phenol, phosphate, sodium hypochlorite, combustion products such as carbon dioxide, carbon monooxide, tars, hydrocarbons, ash/soot, carpet and furniture constituents such as butylated hydroxytoluene, formaldehyde, isooctane, phencyclohexane, propanediol, styrene, vinyl acetate, polybrominated diethyl ether (PBDE's), alchohols such as ethyl, methyl, isopropyl alcohols, propylene glycol, glycerol, adhesives such as butadiene diisocyanates, formaldehyde, styrene, toluene, fragments of organisms such as bacteria, viruses, fungi, protozoans, molecules, allergens, etc that have been partially degraded by the immune system.

The condition may result from accumulation of toxins from drug use. It is envisaged that the use of a drug will result in accumulation of the drug, or a metabolite of the drug, in the lymphatic system, and that the method will therefore be of some benefit to conditions resulting from drug use. For example, drug use may be chemotherapy for the treatment of diseases such as cancer or infectious disease, for pain management therapies such as use of morphine, or for chronic disease therapies such as use of insulin for diabetes.

The condition may result from accumulation of toxins from normal metabolism. For example, free radicals, ammonia, hybrogen sulfide, methane, butane, cadaverine, putrescine and other toxic molecules can accumulate over time in the lymphatic system as a result of immune system activity and general metabolism.

The condition may be lethargy, fatigue, malaise, weakness, arthralgia, myalgia, insomnia, sleep disturbance, sinus congestion, chest congestion, poor immunity (which can result in, for example, increased incidence of viral and bacterial infections, recurrent Herpes “cold sores” or genital herpes, recurrent mouth ulcers), cognitive dysfunction such as poor concentration, impaired memory, mental vagueness, confusion, and learning difficulties, mood disorders such as mood swings, anxiety, irritability, depression, lack of motivation, loss of libido, Skin rashes and acne, fluid retention, headaches, tachycardia and ectopics.

The condition may be a condition selected from the group consisting of gulf war syndrome, diabetes, Cancer, heart failure, kidney failure, liver failure, chronic auto-immune conditions, lupus, rheumatoid arthritis, Crohn's disease, ulcerative colitis, emphysema, chronic viral illnesses such as Hepatitis C and HIV, chronic substance abuse such as alcohol, tobacco and/or recreational drug abuse, dysbiosis, Leaky gut syndrome, chronic fatigue syndrome, fibromyalgia, recurrent infections, detoxification of toxic drug metabolites from prescription medication, chemotherapy drugs, etc.

### BRIEF DESCRIPTION OF THE DRAWINGS

An embodiment of the present invention will now be described, by way of example only, with reference to the accompanying drawings, in which:

FIG. 1 is a cross sectional view of an embodiment of a therapeutic apparatus according to the present invention;

FIG. 2 is a perspective view of the tank of the apparatus of FIG. 1 illustrating the layout of nozzles; and

FIGS. 3 and 4 are cut away views showing a person submerged in the tank of FIG. 1 up to about their neck.

### DETAILED DESCRIPTION OF THE PREFERRED EMBODIMENT

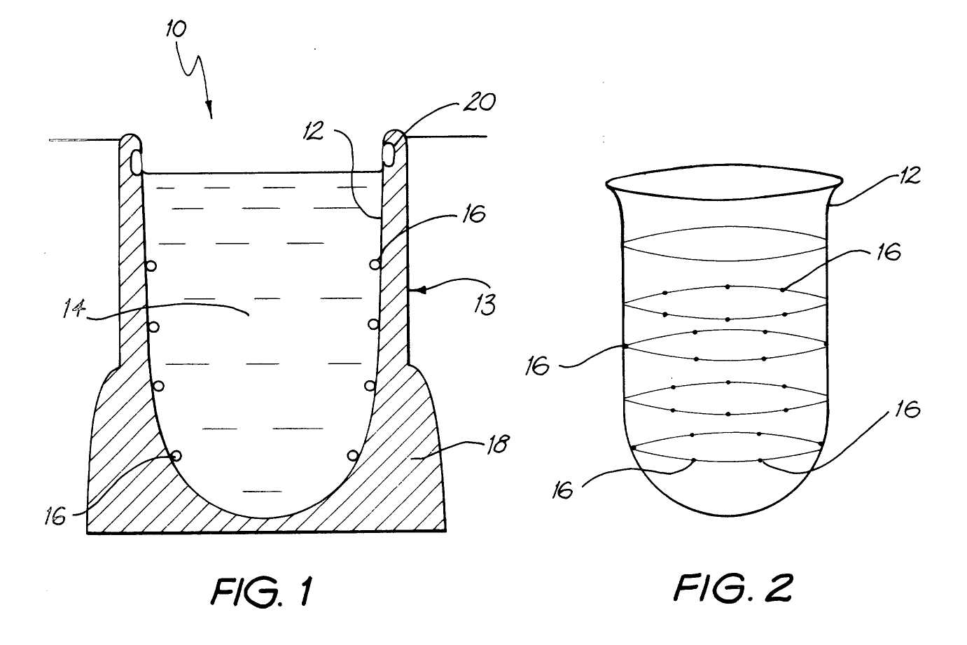

Referring to FIG. 1, a therapeutic apparatus 10 is shown including a tank 12 being the inner wall of moulded fibreglass unit 13. Tank 12 holds a body of fluid in the form of a hyperosmolar solution 14 being a solution of magnesium sulphate in water. The solution has a specific gravity of around 1.3-1.4.

Apparatus 10 includes means for agitating the fluid being a combination of a pump and rotating spa jet nozzles 16. The pump is mounted in machinery housing area 18 which also houses a heater, a filter unit, an ozone generator and a high pressure air pump which also delivers air to the spa jet nozzles 16. The pump acts to expel fluid 14 through nozzles 16. Overflow inlet 20 channels overflow fluid back to the pump. Fluid 14 is continuously recirculated though the pump and is maintained at about 32-34 degrees celsius. Spa nozzles 16 are connected to the air pump via a one-way valve to stop fluid 14 from entering the air pump. Tank 12 is about 2 m deep and 1.2 m in diameter.

Referring to FIG. 2, spa nozzles 16 are shown in a concentric staggered arrangement.

Referring to FIG. 3, a person 22 is shown submerged in fluid 14 up to about their neck. Weights 24 are attached to the person to maintain them submerged in the high density fluid. About 30 lbs of weights are required for an adult, depending upon their weight.

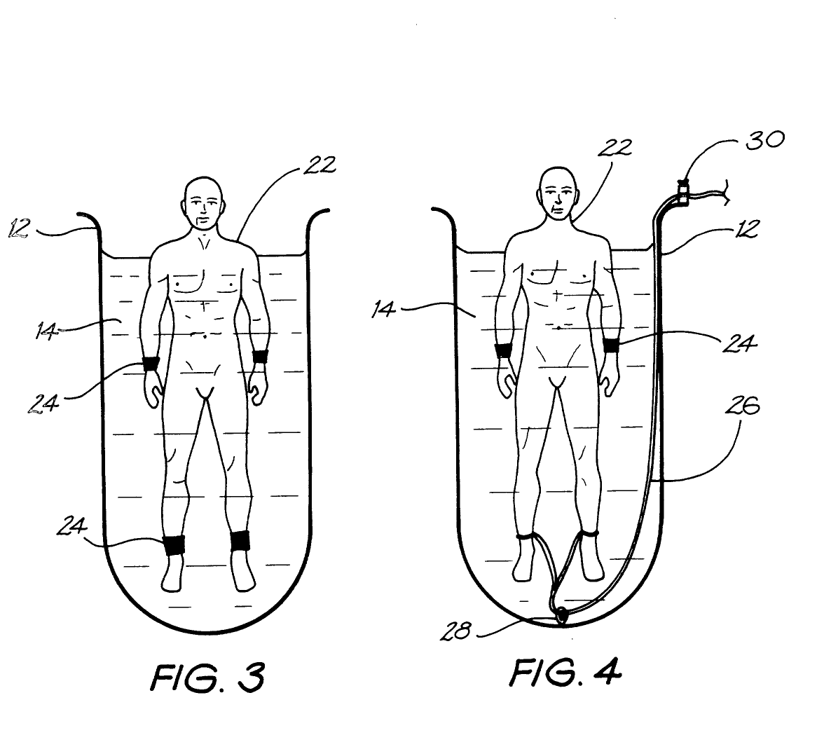

Referring to FIG. 4, an alternative arrangement to FIG. 3 is shown. Tether cord 26 passes through a loop 28 fixed to the bottom of tank 12 and is attached to the ankles of the person. By pulling upwards on cord 26, the person is maintained submerged in fluid 14. Weights 24 maintain the arms of person 22 submerged. A clamp 30 retains tether cord 26 in the correct position. Alternatively, the person 22 can hold onto cord 26 to keep themselves in the correct position.

The person enters tank 12 from a platform (not shown) level with the top of the tank.

### EXAMPLE

A pilot study was conducted to determine whether therapy in the apparatus, combined with far infra-red sauna therapy, led to significant improvements in the energy levels and sense of well-being of participants.

Fifteen study participants were recruited through general practitioners and local newspaper advertising. All participants were female, aged between 29 and 54 years of age. All participants were experiencing current health issues of low energy, fatigue or malaise that was significantly affecting their quality of life and performance of their normal daily activities. The study was conducted over a 6 week period as follows:

| | |
|---|---|
| Week 1-2 | Baseline control - No treatment |
| | Survey monitoring |
| Week 3-4 | 5 combined therapy sessions per week |
| | (20 minutes treatment in apparatus + |
| | 20 minutes Far infra-red therapy) |
| | Survey monitoring |
| Week 5-6 | No treatment |
| | Survey monitoring |

The participants completed ten questionnaires over a 6 week period to establish the three phases for the study: two at baseline (week 1 and 2) before the participants commenced treatment, 6 during the two week course of the ten treatments (weeks 3-4), and two at post-treatment (weeks 5-6).

The questionnaire was based on three broad components:
(a) the CDC healthy days instrument from the US Centres for Disease Control (Measuring Healthy Days, Population Assessment of Health Related Quality of Life, US Department of Health and Human Services, Center for Disease Control and Prevention, Atlanta Ga., November 2000);
(b) a set of questions relating to health impairments and energy levels; and
(c) the full SF-36 Health Survey (Short-form 36 questions developed by John Ware (VP-004 available from Quality Metric Incorporated) that includes overlapping domains for energy and vigour.

The CDC Healthy Days instrument and the SF-36 are well-known and universally recognised questionnaires for the assessment of fatigue.

### Results:

The results of the questionnaires prior to treatment are summarised in Table 1.

TABLE 1
Baseline to week 4

| | % of | % of |
|---|---|---|
| | participants | participants |
| | who | who |
| | experienced an | experienced a |
| | improvement in | deterioration |
| | the effect | in the effect |
| | listed in the | listed in the |
| | left hand | left hand |
| | column. | column. |
| Section II | | |
| Healthy Day Effect | | |
| Number of days lost due to | 46.7% | >50% |
| poor physical health | | |
| The number of days lost due | 46.7% | 7% |
| to poor mental health | | |
| The number of days lost | 46.7% | >50% |
| overall due to poor health | | |
| state to do usual | | |
| activities | | |
| Section III | | |
| Health Impairment Change | | |
| The self-reported number of | 40% | 20% |
| health impairments suffered | | |
| by participants | | |
| The sad/blue/depressed | 40% | 20% |
| level in the previous 30 | | |
| days | | |
| The number of days of | 66.7% | 0% |
| feeling no energy in the | | |
| previous 30 days | | |
| Section IV | | |
| Changes in fitness and | | |
| energy levels | | |
| The ability to concentrate | 60% | 6.7% |
| on daily tasks | | |
| Current overall levels of | 46.7% | 6.7% |
| energy | | |
| Section V | | |
| Overall Health status and | | |
| Quality of life | | |
| (Feelings experienced in | | |
| previous 4 weeks) | | |
| Physical and emotional | 53.3% | 6.7% |
| health affecting | | |
| interactions with the | | |
| family | | |
| The feeling of calm and | 46.7% | 0% |
| peacefulness experienced | | |
| The feeling of energy | 53.3% | 6.7% |
| experienced | | |
| The feeling of experiencing | 46.7% | 13.4% |
| the blues | | |
| The feeling of being worn | 60% | 6.7% |
| out | | |
| The feeling of being happy | 46.7% | 6.7% |
| The feeling of tiredness | 46.7% | 20% |
| The personal feeling of | 40% | 13.3% |
| healthiness | | |

The post-treatment monitoring for fourteen participants was conducted in weeks 5 & 6 of the study. The data were compared for fifty-four indicators in week 1 (baseline), week 4 (week 2 of treatment) and week 6 (week 2 post-treatment) and summarised in Table 2.

TABLE 2
Post-treatment analysis from baseline to week 6

| | % of | % of |
|---|---|---|
| | participants | participants |
| | who | who |
| | experienced an | experienced a |
| | improvement in | deterioation |
| | the effect | in the effect |
| | listed in the | listed in the |
| | left hand | left hand |
| | column. | column. |
| Section II | | |
| Healthy Day Effect | | |
| Number of days lost due to | 57.1% | 7.1% |
| poor physical health | | |
| The number of days lost due | 50% | 0% |
| to poor mental health | | |
| The number of days lost | 50% | 21.4% |
| overall due to poor health | | |
| state to do usual | | |
| activities | | |
| Section III | | |
| Health Impairment Change | | |
| The self-reported number of | 42.9% | 21.4% |
| health impairments suffered | | |
| by participants | | |
| The sad/blue/depressed | 50% | 14.3% |
| level in the previous 30 | | |
| days | | |
| The number of days of | 50% | 14.3% |
| feeling no energy in the | | |
| previous 30 days | | |
| Section IV | | |
| Changes in fitness and | | |
| energy levels | | |
| The ability to concentrate | 42.9% | 7.1% |
| on daily tasks | | |
| Current overall levels of | 57.1% | 7.1% |
| energy | | |
| Section V | | |
| Overall Health status and | | |
| Quality of life | | |
| (Feelings experienced in | | |
| previous 4 weeks) | | |
| Physical and emotional | 71.4% | 7.1% |
| health affecting | | |
| interactions with the | | |
| family | | |
| The feeling of calm and | 50% | 0% |
| peacefulness experienced | | |
| The feeling of energy | 71.4% | 0% |
| experienced | | |
| The feeling of experiencing | 50% | 7.1% |
| the blues | | |
| The feeling of being worn | 64.3% | 0% |
| out | | |
| The feeling of being happy | 57.1% | 7.1% |
| The feeling of tiredness | 64.3% | 7.1% |
| The personal feeling of | Not provided | Not provided |
| healthiness | | |
| The body pain felt | 57.1% | 21.4% |
| The amount of pain felt | 57.1% | 14.3% |
| affecting work | | |
| The feeling of being very | 57.1% | 7.1% |
| nervous | | |
| The down-in-the-dumps | 50% | 0% |
| feeling experienced | | |
| The amount of time physical | 42.9% | 21.4% |
| and emotional problems has | | |
| interfered with social | | |
| activities | | |

### CONCLUSION

The analysis showed there were a number of positive movements towards the desired outcomes on a number of key indicators within the group both in the treatment phase versus baseline and in the post-treatment comparison with baseline.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A therapeutic apparatus including:
a tank arranged to hold a body of fluid being sufficiently deep to submerge an upright person at least up to their neck;
means for agitating the fluid to effect a perturbation massage upon a person submerged in the fluid to mobilise toxins in the person's lymph system.

2. A therapeutic apparatus according to claim 1 further including a body of fluid wherein the fluid has a density greater than water.

3. A therapeutic apparatus according to claim 2 wherein the fluid is a mixture of water and a salt.

4. A therapeutic system according to claim 3 wherein the salt includes a salt of magnesium.

5. A therapeutic system according to any preceding claim wherein the means for agitating includes a pump.

6. A therapeutic system according to any preceding claim wherein the means for agitating further includes nozzles for delivering a jet of pressurised fluid.

7. A therapeutic apparatus according to claim 6 wherein the nozzles are arranged to rotate.

8. A therapeutic system according to any preceding claim further including means to maintain the person in the submerged position.

9. A therapeutic system according to claim 8 wherein the means to maintain the person in the submerged position includes a system of weights or tethers.

10. A method of effecting lymphatic drainage in a person including the steps of:
submerging the person in a body of fluid up to about their neck and in a substantially vertical orientation; and
agitating the fluid to effect a perturbation massage upon the person submerged in the fluid to mobilise toxins in the person's lymph system.

11. A method according to claim 10 wherein the fluid has a density greater than water.

12. A method according to claim 11 wherein the fluid includes a mixture of water and a salt.

13. A method according to claim 12 wherein the salt includes a salt of magnesium.

14. A method according to any one of claims 10 to 13 wherein the step of agitating includes pumping the fluid.

15. A method according to any one of claims 10 to 14 wherein the step of agitating includes the step of delivering the fluid into the tank through nozzles for delivering a jet of pressurised fluid.

16. A method according to claim 15 wherein the nozzles are arranged to rotate.

17. A method according to any one of claims 10 to 16 wherein the person is maintained in the submerged position by a system of weights or tethers.

18. A therapeutic method including the steps of:
submerging the person in a body of fluid up to about their neck and in a substantially vertical orientation; and
agitating the fluid to effect a perturbation massage upon the person submerged in the fluid.

19. A method according to claim 18 wherein the fluid has a density greater than water.

20. A method according to claim 19 wherein the fluid includes a mixture of water and a salt.

21. A method according to claim 20 wherein the salt includes a salt of magnesium.

22. A method according to any one of claims 18 to 21 wherein the step of agitating includes pumping the fluid.

23. A method according to any one of claims 18 to 22 wherein the step of agitating includes the step of delivering the fluid into the tank through nozzles for delivering a jet of pressurised fluid.

24. A method according to claim 23 wherein the nozzles are arranged to rotate.

25. A method according to any one of claims 18 to 24 wherein the person is maintained in the submerged position by a system of weights or tethers.

26. A method of treating a condition in a person comprising the steps of: submerging the person in a body of fluid up to about their neck and in a substantially vertical orientation; and agitating the fluid to effect a perturbation massage upon the person submerged in the fluid to mobilise toxins in the person's lymphatic system.

27. A method according to claim 26 wherein the fluid has a density greater than water.

28. A method according to claim 27 wherein the fluid includes a mixture of water and a salt.

29. A method according to claim 27 wherein the salt includes a salt of magnesium.

30. A method according to any one of claims 26 to 29 wherein the step of agitating includes pumping the fluid.

31. A method according to any one of claims 26 to 30 wherein the step of agitating includes the step of delivering the fluid into the tank through nozzles for delivering a jet of pressurised fluid.

32. A method according to claim 31 wherein the nozzles are arranged to rotate.

33. A method according to any one of claims 26 to 32 wherein the person is maintained in the submerged position by a system of weights or tethers.

34. A method according to any one of claims 26 to 33 further comprising the step of elevating the body temperature of the person to thereby cause the person to perspire.

35. A method according to claim 34 wherein the body temperature is elevated subsequent to removal of the person from the fluid.

36. A method according to claim 34 or 35 wherein the body temperature is elevated by exposing the person to a dose of infra-red radiation that is sufficient to cause the person to perspire.

37. A method according claim 36 wherein the person is exposed to infra-red radiation in an infra-red sauna.

38. A method according to any one of claims 26 to 29 wherein the condition is associated with the accumulation of toxins in the lymphatic system of the person.

39. A method according to any one of claims 26 to 38 wherein the condition is selected from the group consisting of lethargy, fatigue, malaise, weakness, arthralgia, myalgia, insomnia, sleep disturbance, sinus congestion, chest congestion, poor immunity, cognitive dysfunction, learning difficulties, mood disorders, lack of motivation, loss of libido, Skin rashes, acne, fluid retention, headaches, tachycardia, ectopics, gulf war syndrome, diabetes, cancer, heart failure, kidney failure, liver failure, chronic auto-immune conditions, lupus, rheumatoid arthritis, Crohn's disease, ulcerative colitis, emphysema, Hepatitis C, HIV, chronic substance abuse, dysbiosis, Leaky gut syndrome, chronic fatigue syndrome, fibromyalgia, recurrent infections, and detoxification of toxic drug metabolites from prescription medication or chemotherapy drugs.
